(19) United States
(12) Patent Application Publication
(10) Pub. No.: US 2022/0185735 A1
(43) Pub. Date: Jun. 16, 2022

(54) IMPROVED GEOPOLYMER CEMENT

(71) Applicant: MAKENIT PTY LTD, Sydney (AU)

(72) Inventor: Martin Piekkala-Fletcher, Sydney (AU)

(73) Assignee: MAKENIT PTY LTD, Sydney (AU)

(21) Appl. No.: 17/442,551

(22) PCT Filed: Mar. 26, 2020
(86) PCT No.: PCT/AU2020/050288

§ 371 Date: Sep. 23, 2021

(30) Foreign Application Priority Data
Mar. 26, 2019 (AU) 2019901011

(51) Int. Cl. C04B 28/26; C04B 22/10; C04B 22/00; C04B 24/38; C04B 40/00

(52) U.S. Cl. CPC C04B 28/26; C04B 22/10; C04B 2103/44; C04B 24/383; C04B 40/0042; C04B 22/0013

(57) ABSTRACT

The present invention provides a geopolymer cement, comprising: a geopolymer binder; and a setting control composition comprising: a viscosity control agent, a polymeric binder, and a retarding additive. The invention also relates to a geopolymer concrete comprising the geopolymer cement of the invention and aggregate material. The invention further relates to a method for controlling open time in a geopolymer composition, wherein a sufficient quantity of the setting control composition is added such that the open time is between 30 and 120 minutes. The present invention provides particular uses in construction of walls, flooring, and roofing, especially lightweight prefabricated panels intended to be used as structural, insulating or cladding elements.

### FIELD OF THE INVENTION

The present invention relates to the field of geopolymer cements and concretes for use in construction. However, it will be appreciated that the invention is not limited to this particular field of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Concrete made from Portland cement (also known as Ordinary Portland Cement (OPC)) is a construction material frequently used in civil engineering infrastructures. However, a number of environmental concerns in relation to greenhouse gas emissions, energy intensive mining processes, and hazardous ingredients have led to searches for alternatives, one of which is geopolymers. Geopolymer concrete is a low greenhouse gas emission alternative to Portland cement concrete, with emission reductions of up to 80-90% relative to OPC achievable, as well as having other advantages such as improved fire resistance.

The curing mechanism of OPC is different to the way geopolymers cure. Portland cement clinker is a hydraulic material which consists of at least two-thirds by mass of tri- and di-calcium silicates, (3 CaO SiO₂, and 2 CaO SiO₂, respectively), the remainder consisting of aluminum- and iron-containing clinker phases and other compounds. When mixed with water, the cement hardens through a hydration process, which is a chemical reaction in which the major compounds in cement form chemical bonds with water molecules and become hydrates or hydration products. Only the calcium silicates contribute to strength. Tricalcium silicate is responsible for most of the early strength (first 7 days). Dicalcium silicate, which reacts more slowly, contributes only to the strength at later times.

Upon the addition of water, tricalcium silicate rapidly reacts to release calcium ions, hydroxide ions, and a large amount of heat. The pH quickly rises to over 12 because of the release of alkaline hydroxide (OH—) ions. The reaction slowly continues producing calcium and hydroxide ions until the system becomes saturated. Once this occurs, the calcium hydroxide starts to crystallize. Simultaneously, calcium silicate hydrate (CSH) gel and portlandite (Ca(OH)₂) begin to form. Ions precipitate out of solution accelerating the reaction of tricalcium silicate to calcium and hydroxide ions. The evolution of heat then dramatically increases. The formation of the calcium hydroxide and CSH crystals provide “seeds” upon which more CSH can form. The CSH crystals continue to grow during the hydration phase, and when they occupy the interstitial voids and lock together, the cement hardens into a final mass.

Geopolymers are inorganic materials that form long-range, covalently bonded, non-crystalline (amorphous) networks. Geopolymers are essentially a mineral chemical compound or mixture of compounds consisting of repeating units, for example silico-oxide (—Si—O—Si—O—), silico-aluminate (—Si—O—Al—O—), ferro-silico-aluminate (—Fe—O—Si—O—Al—O—) or alumino-phosphate (—Al—O—P—O—), created through a process of geopolymerization. An example of zeolitic (Si—O—Al—O—) geopolymerization with fly ash in alkaline medium involves 5 main phases:
nucleation stage in which the aluminosilicates from the fly ash particle dissolve in the alkaline medium (Na+), releasing aluminates and silicates, which are likely monomers.
These monomers inter-react to form dimers, which in turn react with other monomers to form trimers, tetramers and so on.
When the solution reaches saturation, an aluminum-rich gel precipitates (Gel 1).
As the reaction progresses, more Si—O groups from the initial solid source dissolve, increasing the silicon concentration in the medium and gradually raising the proportion of silicon in the zeolite precursor gel (Gel 2).
Finally, there is polycondensation into zeolite-like 3D-frameworks.

Generally, geopolymer concrete is formed by mixing a binder (also known as “cement”) and aggregates (such as gravel and sand) with water. The binder typically includes metallurgical slags and/or coal fly ash mixed with an alkaline activator such as sodium hydroxide (liquid) or a mixture of sodium carbonate and sodium silicate (solid). The activator provides a high pH solution when mixed with water to activate the geopolymer cement by increasing the reactivity of the silico-aluminate material.

There are numerous advantages of these alkali activated aluminosilicates (“geopolymer binder”) systems, including: lower heat of hydration, the development of earlier and higher mechanical properties, low heat release, better resistance against chemical attack, freeze-thaw resistance, fire resistance, higher reduction in chloride diffusion, and stronger aggregate matrix interface formation. However, geopolymer binders present some problems, such as: rapid setting periods, higher shrinkage values, higher formation of salt efflorescence, faster carbonation, and a tendency to crack during curing. It is a preferred object of the present invention to address one or more of these problems whilst preferably retaining the inherent advantages that geopolymer binders provide.

Geopolymeric reaction of thermally activated aluminosilicate mineral such as fly ash proceeds at a very rapid rate and leads to extremely rapid gelation and setting of the material. Typically, when fly ash alone is reacted with an alkali metal chemical activator, the gelation of the material starts within 2 to 3 minutes and the final set is reached in less than 10 minutes after the formation of an aqueous mixture. From a practical perspective, rapid gelation and setting times mean that it is difficult to use geopolymer binders in real-world applications as there is insufficient time to pour the material into a mould as flowability quickly reduces over time. In some cases, the set time is so fast that the binder sets in the mixer. What is required is a geopolymer binder which has a gelation period that ranges between 20 to 60 minutes, with final setting times of about 30 to about 120 minutes. Preferably the gelation and setting times are controllable. Increased gelation and final setting times allow for longer open and working times.

One method known in the art to adjust the open time for systems based on geopolymer binders is to increase the amount of water used in the mixture. Adding water improves the flowability of the initial slurry, however adding water to delay the gelation and setting time has a significant detrimental effect on the final compressive strength (and on other properties). This is the case even despite geopolymer binder systems being recognized as having greater mechanical properties compared to traditional OPC binder systems. What is therefore needed is a way to use the minimum or ideal amount of water to prepare a geopolymer binder, and yet have a flowable mixture with longer open time, and also achieve the improved mechanical properties that geopolymer binders provide.

As explained above, and as understood by the person skilled in the art, the constituents of OPC and geopolymer are different, the chemical reactions are different, the mechanisms by which hardening and strength develop are different, the chemical species in the water environment are different, and the water concentrations can be different. Accordingly, due to these significant differences, additives which may deliver a benefit in one binder system may not necessarily deliver the same benefits in a different binder system. For example, it is known in the art to use a cure-retarding agent (which is common in OPC binders) in geopolymer binder-based system. However, when used in a geopolymer binder, these cure retarding agents are not able to deliver an open time within the desired range, and appear to have an initial effect that diminishes with increasing concentration. Furthermore, these additives can negatively impact flowability, surface finish, and the mechanical properties, especially compressive strength. In this regard, we refer to the experimental data in the Examples section below.

When a geopolymer polymerises or “cures”, water is released. This water, expelled from the geopolymer matrix during the curing and further drying periods, leaves behind discontinuous nano-pores in the matrix. These provide benefits to the performance of geopolymers, such as increased resistance to acid when compared to Portland cement-based concrete formulations. The water in a geopolymer mixture, therefore, plays no role in the chemical reaction that takes place; it merely provides workability to the mixture during handling. In contrast, water is essential to the hydration reaction in a Portland cement-based concrete mixture and most Portland cement based concrete formulations must be kept covered with water to enable the curing process to occur. These differences are important and significant, and influence how different additives perform in these different binder systems. As such, water-based additives which deliver a benefit in OPC may not necessarily deliver the same benefit in a geopolymer binder system.

A preferred object of the present invention is to provide a geopolymer binder system that has a longer and controllable open time, and which and provides excellent mechanical properties, is flowable to enable pouring, and which results in acceptable surface finish by reducing or avoiding the tendency to crack during curing. A further preferred object of the present invention is to provide a geopolymer based concrete that develops strength at approximately the same rate as OPC-based concrete, thereby enabling use of the present invention in real-world applications. Yet a further preferred object of the present invention is to provide a geopolymer based binder system that is thermally insulative. Yet a further preferred object of the present invention is to provide a setting control composition which is in the form of a powder or slurry that can be dosed into a geopolymer binder on-site and as required.

It is an object of the present invention to overcome or ameliorate one or more the disadvantages of the prior art, or at least to provide a useful alternative.

### SUMMARY OF THE INVENTION

The present invention relates to geopolymer based binders. In particular, the invention relates to the use of a setting control composition for use with a geopolymer binder. The setting control composition comprises the combination of a viscosity control agent, a polymeric binder, and a retarding additive. The combination of these components surprisingly provides longer and controllable open times in geopolymer based binders, thereby providing a more workable and flowable composition which can be used in real-world applications. Furthermore, because the components are in a powdered form, they can be dosed into a geopolymer binder on-site and as required. Further still, surprisingly there is no negative impact upon mechanical properties, and the surface finish of the resulting cured material is improved compared to a geopolymer based material produced without the setting control composition of the invention. Also, surprisingly the geopolymer cement/concrete of the invention develops strength at approximately the same rate as OPC-based concretes.

The ability of the modified geopolymer based concretes/cements of the invention to achieve very high strength (e.g., up to around 100 MPa), which is well in excess of the strength achievable with OPC-based concretes, enables density modifiers to be added to form light weight panels which have strength comparable to a concrete panel formed from OPC, but without any density modification. Addition of density modifiers enables insulated structural panels to be formed, which avoids the need for the use of traditional insulation material for walls and ceilings, which is labour-intensive and adds cost to the building. By way of comparison, aerated OPC-based concrete needs to have a density of around 1250 kg/m³ or less to be an effective insulation material. This density can be relatively easily achieved, however aerated OPC concrete at this density has poor compressive strength, and cannot be used in structural applications.

The setting control composition of the present invention has been found to increase the gelation and final setting times of a geopolymer cementitious composition. For the geopolymer cementitious compositions of the invention, the gelation period ranges between 20 to 60 minutes, with final setting times of about 30 to about 120 minutes. The increased gelation and final setting times allow longer open and working times.

According to a first aspect of the present invention, there is provided a geopolymer cement, comprising:

a geopolymer binder; and

a setting control composition comprising:
a viscosity control agent,
a polymeric binder, and
a retarding additive.

Geopolymer Binder

In some preferred embodiments, the geopolymer cementitious compositions of the invention are formed from solutions or slurries of at least water and one or more cementitious reactive components in a dry or powder form. The cementitious reactive components comprise an effective amount of thermally activated geopolymer aluminosilicate materials, such as fly ash or slag. Other suitable aluminosilicates include metakaolin, pumice, allophane, and bentonite. The cementitious reactive component also comprises an alkaline silicate solution, such as a mixture of an alkali metal silicate and metal hydroxide.

Fly ash is a fine powder by-product formed from the combustion of coal. Electric power plant utility furnaces burning pulverized coal produce most of the commercially available fly ashes. These fly ashes comprise mainly of glassy spherical particles, as well as hematite and magnetite, unburned carbon, and some crystalline phases formed during cooling. The structure, composition and properties of fly ash particles depend upon the composition of the coal and the combustion process by which fly ash is formed. American Society for Testing and Materials (ASTM) C618 standard recognizes two major classes of fly ashes for use in concrete: Class C and Class F. All ASTM standards and their specifications described in this disclosure are incorporated by reference in their entirety. Class F fly ash is normally produced from burning anthracite or bituminous coal, whereas Class C fly ash is normally produced from lignite or sub-bituminous coal. The ASTM C618 standard differentiates Class F and Class C fly ashes primarily according to their pozzolanic properties. Accordingly, in the ASTM C618 standard, one major specification difference between the Class F fly ash and Class C fly ash is the lower limit of (SiO₂+Al₂O₃+Fe₂O₃) in the composition. The lower limit of (SiO₂+Al₂O₃+Fe₂O₃) for Class F fly ash is 70% and that for Class C fly ash it is 50%. Accordingly, Class F fly ashes generally have a calcium oxide content of about 15 wt % or less, whereas Class C fly ashes generally have a higher calcium oxide content (e.g., higher than 15 wt %, such as 20 to 40 wt %). The Class C material has proven problematic for use in producing a geopolymer product with a setting time sufficiently long enough to enable satisfactory mixing, pouring and moulding of the geopolymer. It has been postulated that the presence of large amounts of calcium is responsible for this fast setting behaviour.

Ground granulated blast furnace slag is obtained by quenching molten iron slag (a by-product of iron and steel manufacture) from a blast furnace in water or steam to produce a glassy granular product that is then dried and ground into a fine powder. Preferably, the blast furnace slag is ground to less than about 100 μm. Even more preferably, the blast furnace slag is ground to less than about 75 μm. In particular, the blast furnace slag is ground to less than about 50 μm.

The cementitious reactive component also comprises an alkaline silicate solution, such as a mixture of an alkali metal silicate and metal hydroxide. The metal silicate can be an alkali metal silicate and/or alkaline earth metal silicate. Alkali metal silicates, particularly sodium silicate, are desirable. Sodium silicate with a mass ratio of SiO₂/Na₂O equal to about 2 to 3.2 is preferred. The sodium silicate solution preferably comprises about 38 to 55 wt % alkali silicate solids and about 45% to 62 wt % water. An alkaline silicate solution can be prepared by diluting commercially available sodium silicate solution with water and adding solid sodium hydroxide to adjust the solution with target concentrations of Na₂O and SiO₂. Alternately, fumed silica can also be used by dissolving it in an alkali hydroxide solution.

In other embodiments, the geopolymeric composition according to the invention uses a metal silicate, with the metal selected from the group consisting of lithium, potassium, rubidium and cesium. Preferably, the metal is potassium. In another embodiment, the metal silicates can be replaced by ammonium silicates.

In some preferred embodiments, the amount of alkali metal chemical activator is from about 1% to about 10% by weight based upon the total dry weight of the cementitious reactive materials. More preferably, the range of alkali metal chemical activator about 2% to about 8% by total weight of the cementitious reactive materials, preferably about 4% to about 8%, more preferably about 6% to about 9%, and most preferably about 7% to 8%. Sodium citrate and potassium citrate are preferred alkali metal acid activators, although a blend of sodium and potassium citrate can also be used. Alkali metal bases, such as alkali metal hydroxides, and alkali metal silicates also may be used depending on the application and the needs of that application.

A preferred geopolymer binder for use in the present invention is disclosed in International PCT Publication No. WO 2014/075134, the content of which is incorporated herein in its entirety by reference. WO 2014/075134 describes a solid component activator for use in a geopolymer cement containing a silico-aluminate material, comprising a mixture of sodium silicate and sodium carbonate for activating the geopolymer cement by increasing reactivity of the silico-aluminate material. The silico-aluminate material preferably includes fly ash having a median particle size ranging from 3 to 20 microns. The solid component activator of WO 2014/075134 is stable in the atmosphere unlike activators such as hygroscopic sodium hydroxide that readily absorb moisture from the atmosphere. Accordingly, the solid component activator can be pre-mixed with silico aluminate material to create a cement and the cement can be stored stably before being transported and/or sold in a ready-for-use dry powder form.

In one embodiment, there is the proviso that the geopolymer compositions of the invention are devoid of cements, such as calcium aluminate cement, calcium sulfoaluminate cement, OPC, etc.

Viscosity Control Agents

Preferred cellulose based organic polymers useful for viscosity control in the geopolymer compositions of the present invention include methylcellulose (MC), methylhydroxyethylcellulose (MHEC), methylhydroxypropylcellulose (MHPC), hydroxyethylcellulose (HEC), ethylhydroxyethylcellulose (EHEC), methylethylhydroxyethylcellulose (MEHEC), hydrophobically modified ethylhydroxyethylcelluloses (HMEHEC), hydrophobically modified hydroxyethylcelluloses (HMHEC), sulfoethyl methylhydroxyethylcelluloses (SEMHEC), sulfoethyl methylhydroxypropylcelluloses (SEMHPC), sulfoethyl hydroxyethylcelluloses (SEHEC), hydroxypropyl-cellulose (HPC), hydroxypropylmethyl-cellulose (HPMC), methyl-cellulose (MC), ethyl-cellulose (EC), methylethyl-cellulose (MEC), carboxymethyl-cellulose (CMC), carboxymethyl-ethyl-cellulose (CMEC), and carboxymethylhydroxyethyl-cellulose (CMREC).

Any cellulose ether that is soluble in water at 20° C. is believed to be suitable for use in the present invention. In such compounds, the hydroxyl groups present in cellulose may be partially or fully replaced by —OR groups, wherein R is selected from a (C₁-C₆) alkyl group, a hydroxyalkyl (C₁-C₆) alkyl group and mixtures thereof. The presence of an alkyl substitution in cellulose ether is conventionally described by the DS, i.e. the average number of substituted OH groups per anhydroglucose unit. For example, a methyl substitution is specified as DS (methyl) or DS (M). Similarly, the presence of a hydroxyalkyl substitution is conventionally described by the MS, i.e. the average number of moles of the esterification reagent which are bound in an ether-like manner per mole of anhydroglucose units. For example, the etherification with the ethylene oxide is stated as MS (hydroxy ethyl) or MS (HE) and the etherification with propylene oxide as MS (hydroxypropyl) or MS (HP).

Polymeric Binders

Preferred polymeric binders used in the present invention are film forming redispersible polymer powders such as latex powders. These polymer powders are water-redispersible and produced by spray drying of aqueous polymer dispersions (latex). Latex is a water-based polymer dispersion (emulsion polymer), widely used in industrial applications. Latex is a stable dispersion (colloidal emulsion) of polymer microparticles in an aqueous medium. Thus, it is a suspension/dispersion of rubber or plastic polymer microparticles in water. Latexes may be natural or synthetic.

The latex is preferably made from a pure acrylic, a styrene rubber, a styrene butadiene rubber, a styrene acrylic, a vinyl acrylic or an acrylated ethylene vinyl acetate copolymer and is more preferably a pure acrylic. Preferably latex polymer is derived from at least one acrylic monomer selected from the group consisting of acrylic acid, acrylic acid esters, methacrylic acid, and methacrylic acid esters. For example, the monomers preferably employed in emulsion polymerization include such monomers as methyl acrylate, ethyl acrylate, methyl methacrylate, butyl acrylate, 2-ethyl hexyl acrylate, other acrylates, methacrylates and their blends, acrylic acid, methacrylic acid, styrene, vinyl toluene, vinyl acetate, vinyl esters of higher carboxylic acids than acetic acid, e.g. vinyl versatate, acrylonitrile, acrylamid, butadiene, ethylene, vinyl chloride and the like, and mixtures thereof. For example, a latex polymer can be a butyl acrylate/methyl methacrylate copolymer or a 2-ethylhexyl acrylate/methyl methacrylate copolymer. Preferably, the latex polymer is further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C₄-C₈ conjugated dienes.

Vinyl acetate ethylene (VAE) emulsions are based on the copolymerization of vinyl acetate and ethylene, in which the vinyl acetate content can range between 60 and 95 percent, and the ethylene content ranges between 5 and 40 percent of the total formulation. This product should not be confused with the ethylene vinyl acetate (EVA) copolymers, in which the vinyl acetate generally ranges in composition from 10 to 40 percent, and ethylene can vary between 60 and 90 percent of the formulation. VAEs are water-based emulsions and these emulsions can be dried to form redispersible powders, whereas EVAs are solid materials used for hotmelt and plastic molding applications.

Set Retarding Additives

Suitable set retarding additives comprise boron containing compounds, which include but are not limited to anhydrous or hydrated Group I metal borates, for example borax (hydrated sodium borate), or pure oxides of boron, but are not limited thereto. Borax/borate is currently preferred for use.

Other Additives

Other additives may be incorporated into the slurry and overall geopolymeric cementitious composition of the invention. Such other additives, for example, set accelerating agents, air-entraining agents, foaming agents, wetting agents, shrinkage control agents, efflorescence control (suppression) agents, colouring agents, corrosion control agents, alkali-silica reaction reducing admixtures, and discrete reinforcing fibers. Other additives may include fillers, such as one or more of sand and/or other aggregates, lightweight fillers, mineral fillers, etc.

Air Entraining Agent

Air entraining agents (also known as foaming agents) may be added to the geopolymer compositions of the invention to form air bubbles (foam) in situ. Air entraining agents are preferably surfactants used to purposely trap microscopic air bubbles in the geopolymer binder. Alternatively, air entraining agents are employed to externally produce foam which is introduced into the mixtures of the compositions of some embodiments of the invention during the mixing operation to reduce the density of the product. Preferably to externally produce foam the air entraining agent (also known as a liquid foaming agent), air and water are mixed to form foam in a suitable foam generating apparatus. A foam stabilizing agent such as polyvinyl alcohol can be added to the foam before the foam is added to the geopolymer binder slurry.

Examples of air entraining/foaming agents include alkyl sulfonates, alkylbenzolfulfonates and alkyl ether sulfate oligomers among others. Details of the general formula for these foaming agents can be found in U.S. Pat. No. 5,643,510 incorporated herein by reference.

An air entraining agent (foaming agent) such as that conforming to standards as set forth in ASTM C 260 “Standard Specification for Air-Entraining Admixtures for Concrete” (Aug. 1, 2006) can be employed. Such air entraining agents are well known to those skilled in the art and are described in the Kosmatka et al “Design and Control of Concrete Mixtures,” Fourteenth Edition, Portland Cement Association, specifically Chapter 8 entitled, “Air Entrained Concrete,” (cited in US Patent Application Publication No. 2007/0079733 A1).

Suitable air entraining (foaming) agents include water soluble salts (usually sodium) of wood resin, vinsol resin, wood rosin, tall oil rosin, or gum rosin; non-ionic surfactants (e.g., such as those commercially available from BASF under the trade name TRITON X-100); sulfonated hydrocarbons; proteinaceous materials; or fatty acids (e.g., tall oil fatty acid) and their esters.

Commercially available air entraining materials include vinsol wood resins, sulfonated hydrocarbons, fatty and resinous acids, aliphatic substituted aryl sulfonates, such as sulfonated lignin salts and numerous other interfacially active materials which normally take the form of anionic or nonionic surface-active agents (surfactants), sodium abietate, saturated or unsaturated fatty acids and salts thereof, tensides, alkyl-aryl-sulfonates, phenol ethoxylates, lignosulfonates, resin soaps, sodium hydroxystearate, lauryl sulfate, ABSs (alkylbenzenesulfonates), LASs (linear alkylbenzenesulfonates), alkanesulfonates, polyoxyethylene alkyl(phenyl) ethers, polyoxyethylene alkyl(phenyl)ether sulfate esters or salts thereof, polyoxyethylene alkyl(phenyl)ether phosphate esters or salts thereof, proteinic materials, alkenylsulfosuccinates, alpha-olefinsulfonates, a sodium salt of alpha olefin sulphonate, or sodium lauryl sulphate or sulphonate and mixtures thereof.

An air-entraining agent may be used in an amount of 0 to 1, preferably 0.01-0.5, more preferably 0.01-0.2, most preferably 0.05-0.2 weight % based upon the total weight of the geopolymer binder. In preferred embodiments, the final cured material has an air content of about 4% to 20% by volume, more preferably about 4% to 12% by volume, and most preferably about 4% to 8% by volume.

Defoaming Agents

Defoaming agents can be added to the geopolymer compositions of some embodiments of the invention to reduce the amount of entrapped air, increase material strength, increase material bond strength to other substrates, and to produce a defect free surface in applications where surface aesthetics is an important criteria. Examples of suitable defoaming agents useful in the geopolymer compositions of the invention include polyethylene oxides, propoxylated amines, polyetheramine, polyethylene glycol, polypropylene glycol, alkoxylates, polyalkoxylate, fatty alcohol alkoxylates, hydrophobic esters, tributyl phosphate, alkyl polyacrylates, silanes, silicones, polysiloxanes, polyether siloxanes, acetylenic dials, tetramethyl decynediol, secondary alcohol ethoxylates, silicone oil, hydrophobic silica, oils (mineral oil, vegetable oil, white oil), waxes (paraffin waxes, ester waxes, fatty alcohol waxes), amides, fatty acids, polyether derivatives of fatty acids, etc., and mixtures thereof.

Preferably a defoaming agent may be used in an amount of 0 to 0.5, preferably 0-0.25, more preferably 0.01-0.1 weight % based upon the total weight of the polymer binder.

Fillers-Fine Aggregate, Coarse Aggregate, Inorganic Mineral Fillers and Lightweight Fillers

One or more fillers such as fine aggregate, coarse aggregate, inorganic mineral fillers, and lightweight fillers may be used as a component in compositions of the invention. These fillers are not pozzolans or thermally activated aluminosilicate minerals.

Fine aggregates can be added to the geopolymer compositions in the invention without affecting the properties to increase the yield of the material. An example of fine aggregate is Sand. Sand is defined as an inorganic rock material with an average particle size of less than about 4.75 mm. The sand used in this invention preferably meet the standard specifications of the ASTM C33 standard. Preferably the sand has a mean particle size of 0.1 mm to about 3 mm. More preferably the sand has a mean particle size of 0.2 mm to about 2 mm. Most preferably the sand has a mean particle size about 0.3 to about 1 mm. Examples of preferable fine sand used in some embodiments of this invention include QUIKRETE FINE No. 1961 and UNIMIN 5030 having a predominant size range of US sieve number #70-#30 (0.2-0.6 mm). The fine aggregate used in this invention meet the ASTM C33 standard performance.

Inorganic mineral fillers are dolomite, limestone, calcium carbonate, ground clay, shale, slate, mica and talc. Generally, they have a fine particle size with preferably average particle diameter of less than about 100 microns, preferably less than about 50 microns, and more preferably less than about 25 microns in the compositions of some embodiments of the invention.

Coarse aggregates can be added to the geopolymer compositions without it affecting any of the properties to increase the yield of the material. Coarse aggregate is defined as an inorganic rock material with an average particle size at least 4.75 mm, for example 0.64 to 3.81 cm. Aggregate with size larger than 3.81 cm may also be used in some applications for example concrete pavement. The particle shape and texture of the coarse aggregate used can be angular, rough-textured, elongated, rounded or smooth or a combination of these. Preferably coarse aggregate are made of minerals such as granite, basalt, quartz, riolite, andesite, tuff, pumice, limestone, dolomite, sandstone, marble, chert, flint, greywacke, slate, and/or gneiss. Coarse aggregate useful in some embodiments of the invention as listed in TABLE A-2 and D meets specifications set out in ASTM C33 (2011) and AASHTO M6/M80 (2008) standards. Gravel is a typical coarse aggregate.

Lightweight fillers have a specific gravity of less than about 1.5, preferably less than about 1, more preferably less than about 0.75, and still more preferably less than about 0.5. In some other preferred embodiments of the invention the specific gravity of lightweight fillers is less than about 0.3, more preferably less than about 0.2 and most preferably less than about 0.1. In contrast, inorganic mineral filler preferably has a specific gravity above about 2.0. Examples of useful lightweight fillers include pumice, vermiculite, expanded forms of clay, shale, slate and perlite, scoria, expanded slag, cinders, glass microspheres, synthetic ceramic microspheres, hollow ceramic microspheres, lightweight polystyrene beads, plastic hollow microspheres, expanded plastic beads, and the like. Expanded plastic beads and hollow plastic spheres when used in the composition of some embodiments of the invention are employed in very small quantity on a weight basis owing to their extremely low specific gravity.

When lightweight fillers are utilized to reduce the weight of the material, they may be employed at filler to cementitious materials (reactive powder) ratio of about 0 to about 2, preferably about 0.01 to about 1, preferably about 0.02 to about 0.75. One or more types of lightweight fillers may be employed in the geopolymer compositions of the invention.

Efflorescence Suppression Agent

Water repelling agents such as silanes, silicones, siloxanes, stearates are added to the cementitious compositions of some embodiments of the invention to reduce efflorescence potential of the material. Selected examples of useful efflorescence suppression agents include octyltriethoxy silane, potassium methyl siliconate, calcium stearate, butyl stearate, polymer stearates. These efflorescence control agents reduce the transport of the water within the hardened material and thereby minimize migration of salts and other soluble chemicals that can potentially cause efflorescence. Excessive efflorescence can lead to poor aesthetics, material disruption and damage from expansive reactions occurring due to salt accumulation and salt hydration, and reduction in bond strength with other substrates and surface coatings.

Fibres

Compositions of the invention may include fibres, which may be chosen from the group comprising, mineral, animal, plant and synthetic fibres, more particularly from the group comprising, polyamide, polyacrylonitrile, polyacrylate, cellulose, polypropylene, polyvinyl alcohol, glass, metal, flax, polycarbonate, sisal, jute, hemp fibres and mixtures of these fibres.

Water Repellent

Compositions of the invention may include water repellent, which may be chosen from the group comprising, fluorinated, silanized, siliconated, siloxanated agents, fatty acid metal salts and mixtures thereof, preferably from the sodium, potassium and/or magnesium salts of oleic and/or stearic acids and mixtures thereof.

Colouring Agent

Compositions of the invention may include colouring agent, which may be chosen from the group comprising, organic and/or mineral pigments, and more particularly from the oxides of iron, titanium, chromium, tin, nickel, cobalt, zinc, antimony, and/or from polysulphurated sodium aluminosilicates, carbon, the sulphides of cobalt, manganese, zinc, and/or from the high-transparency or highly infrared-reflective pigments and mixtures thereof.

Properties of a Geopolymer Concrete of the Invention

The geopolymer cementitious binders of the invention are capable of developing compressive strength after 1 to 4 hours of about 5 MPa to about 10 MPa, about 10 MPa to about 55 MPa after 24 hours, and about 25 MPa to about 100 MPa after 28 days.

Form of the Setting Control Composition

Preferably the setting control composition of the invention is in the form of a powder. It will be appreciated that transportation of a powder minimises transportation costs and improves the ease with which the setting control composition of the invention can be mixed into the geopolymer binder. Other suitable forms are a paste or slurry.

Water Content

Preferred water:cement ratios are 0.15 to 0.25, preferably 0.2. The “cement” is understood to comprise the total of the pre-mix load of solids, such as slag, sodium carbonate, sodium metasilicate, borate, HPMC, VAE, and any fillers.

Preferred Compositions

Possible and preferred ranges of the main components of the compositions of the invention are detailed in the following table.

| | | Possible | |
|---|---|---|---|
| | | range | Preferred |
| Component | Preferred example | (wt %) | (wt %) |
| geopolymer binder | Slag; Sodium Carbonate; | 60 to 99 | 95 |
| | Sodium Metasilicate | | |
| viscosity control | Hydroxypropyl | 0.1 to 3.0 | 0.70 |
| agent | methylcellulose | | |
| polymeric binder | Vinyl Acetate - Ethylene | 0.1 to 1.5 | 0.40 |
| | copolymer re-dispersible | | |
| | powder | | |
| set retarding | borax | 1 to 5 | 2.3 |
| additive | | | |
| water:cement ratio | water | 0.15 to 0.25 | 0.20 |

Preferably the geopolymer binder (comprising the aluminosilicate material, such as slag, and the activator, such as sodium carbonate and sodium metasilicate) are included at a total concentration of 60 to 62, 62 to 64, 64 to 66, 66 to 68, 68 to 70, 70 to 72, 72 to 74, 74 to 76, 76 to 78, 78 to 80, 80 to 82, 82 to 84, 84 to 86, 86 to 88, 88 to 90, 90 to 92, 92 to 94, 94 to 95 wt %.

In the case where the activator is sodium carbonate and sodium metasilicate, preferably they are included at a 1:1 ratio, and are included at a concentration of 5 to 5.5, 5.5 to 6.0, 6 to 6.2, 6.2 to 6.4, 6.4 to 6.6, 6.6 to 6.8, 6.8 to 7, 7 to 7.2, 7.2 to 7.4, 7.4 to 7.6, 7.6 to 7.8, 7.8 to 8, 8 to 8.2, 8.2 to 8.4, 8.4 to 8.6, 8.6 to 8.8, 8.8 to 9, 9 to 9.2, 9.2 to 9.4, 9.4 to 9.6, 9.6 to 9.8, or 9.8 to 10%

Preferably the viscosity control agent is included at a concentration of 0.1 to 0.2, 0.2 to 0.3, 0.3 to 0.4, 0.4 to 0.5, 0.5 to 0.6, 0.6 to 0.7, 0.7 to 0.8, 0.8 to 0.9, 0.9 to 1, 1 to 1.1, 1.1 to 1.2, 1.2 to 1.3, 1.3 to 1.4, 1.4 to 1.5, 1.5 to 1.6, 1.6 to 1.7, 1.7 to 1.8, 1.8 to 1.9, 1.9 to 2, 2 to 2.1, 2.1 to 2.2, 2.2 to 2.3, 2.3 to 2.4, 2.4 to 2.5, 2.5 to 2.6, 2.6 to 2.7, 2.7 to 2.8, 2.8 to 2.9, or 2.9 to 3.0 wt %.

Preferably the polymeric binder is included at a concentration of 0.1 to 0.2, 0.2 to 0.3, 0.3 to 0.4, 0.4 to 0.5, 0.5 to 0.6, 0.6 to 0.7, 0.7 to 0.8, 0.8 to 0.9, 0.9 to 1, 1 to 1.1, 1.1 to 1.2, 1.2 to 1.3, 1.3 to 1.4, or 1.4 to 1.5 wt %. In other embodiments, the polymeric binder is included at a concentration of 0.1, 0.2, 0.3, 0.4, 0.5, 0.6, 0.7, 0.8, 0.9, 1.0, 1.1, 1.2, 1.3, 1.4, or 1.5 wt %

Preferably the set retarding additive is borate, which is included at a concentration of between 1 and 5 wt % (based on the 100 wt % of the aluminosilicate). In some embodiments, the borate is included in: 1 to 1.2, 1.2 to 1.4, 1.4 to 1.6, 1.6 to 1.8, 1.8 to 2, 2 to 2.2, 2.2 to 2.4, 2.4 to 2.6, 2.6 to 2.8, 2.8 to 3, 3 to 3.2, 3.2 to 3.4, 3.4 to 3.6, 3.6 to 3.8, 3.8 to 4, 4 to 4.2, 4.2 to 4.4, 4.4 to 4.6, 4.6 to 4.8, or 4.8 to 5 wt %.

Preferably the water:cement ratio is selected from between 0.15 to 0.16, 0.16 to 0.17, 0.17 to 0.18, 0.18 to 0.19, 0.19 to 0.2, 0.2 to 0.21, 0.21 to 0.22, 0.22 to 0.23, 0.23 to 0.24, or 0.24 to 0.25. In other embodiments, the water:cement ratio is: 0.15, 0.16, 0.17, 0.18, 0.19, 0.20, 0.21, 0.22, 0.23, 0.24 or 0.25.

Open Time

For the purposes of the present invention, the term “open time” it is considered synonymous with the terms “working time” and “set time”, which are understood to be the time interval between pouring of the liquid mix into a mould and solidification of the mix. The term “setting” is understood as the process of solidification of the mix during which it hardens and gains strength.

In some embodiments, the composition of the invention may be formulated for a short setting time, such as less than about 10 minutes. In other preferred embodiments, the composition may be formulated for an extended setting of between about 10 to about 30 minutes. In yet other more preferred embodiments, the composition formulation is preferably selected to provide a setting time of about 30 to about 60 minutes. In still other most preferred embodiments, the composition may be formulated for setting times as long as about 60 to about 120 minutes, about 120 to about 240 minutes, or longer times if desired.

In some embodiments, a setting accelerator may be used to partially counteract the extended open time provided by the compositions of the invention, thereby fine tuning the open time to a predetermined time.

Curing

For the purposes of the present invention, the term “curing” is understood as the process of applying heat and/or moisture to the mix after setting under controlled conditions and for a specific period of time to enhance properties such as compressive strength.

The geopolymer composition may be cured by dry heating, fan-assisted heating, steam curing or immersion in water or by other means as are known in the art. Most preferably the geopolymer composition is cured by dry heating or steam curing. The geopolymer composition may be cured at a temperature between about 30 and about 120° C., preferably between 50 and 100° C., more preferably between 80 and 100° C., and even more preferably at 90° C. The time taken to cure the geopolymer composition will usually be between about 1 and about 24 hours, preferably between 12 and 24 hours, and more preferably between 12 and 18 hours.

According to a second aspect of the present invention, there is provided a geopolymer concrete, comprising:
a geopolymer cement according to the first aspect,
water, and
aggregate material,
wherein the concrete has a water to cement ratio of between 0.15 to 0.25.

According to a third aspect of the present invention, there is provided a method of making a geopolymer cement, comprising:
combining a geopolymer binder with a setting control composition, the setting control composition comprising:
   a viscosity control agent,
   a polymeric binder, and
   a retarding additive.

According to a fourth aspect of the present invention, there is provided a method of making a geopolymer concrete, comprising:
combining a solid geopolymer cement according to the first aspect, aggregate material, and water, wherein the water to cement ratio is between 0.15 to 0.25.

According to a fifth aspect of the present invention, there is provided a method for controlling open time in a geopolymer composition, the method comprising:
combining a geopolymer binder with a setting control composition to provide said geopolymer composition, the setting control composition comprising:
   a viscosity control agent,
   a polymeric binder, and
   a retarding additive,
and adding water to the geopolymer composition such that the water to cement ratio is between 0.15 to 0.25,
wherein a sufficient quantity of the setting control composition is added such that the open time is between 30 and 120 minutes.

According to a sixth aspect of the present invention, there is provided the use of a setting control composition for controlling open time of a geopolymer composition, the setting control composition comprising:
a viscosity control agent,
a polymeric binder, and
a retarding additive.

A related aspect provides a kit for controlling the open time of a geopolymer composition, the kit comprising a first container comprising a slurry of viscosity control agent dispersed in water, and a second container comprising powdered forms of polymeric binder and retarding additive. In other embodiments, a kit is provided for controlling the open time of a geopolymer composition, the kit comprising a first container comprising a slurry of viscosity control agent and polymeric binder dispersed in water, and a second container comprising powdered retarding additive. In other embodiments, the kit comprises a single container having a mixture of powdered viscosity control agent, powdered polymeric binder, and powdered retarding additive. In this embodiment the kit comprises a water-soluble plastic container, such that the entire kit can be deposited into a water-based slurry of geopolymer cement, whereby the water-soluble plastic container dissolves quickly (e.g., within minutes) and releases the powders into the cement. Each kit can therefore be considered as a single dose of setting control composition. Apart from the convenience that this embodiment provides, a further advantage is that the plastic container can be sized such that a predetermined open time can be obtained by including a predetermined number of kits/doses. For example, each dose can provide, say 20 minutes open time, and therefore if a one-hour open time is required 3 doses can be incorporated into the base geopolymer cement slurry.

Preferred embodiments of the invention comprise a pre-mix of all the solid components of the formulation.

According to a seventh aspect of the present invention, there is provided the use of a geopolymer cement according to the first aspect or a concrete according to the second aspect in construction.

Preferred uses of the geopolymer cement or geopolymer concrete according to the invention are in construction applications such as: walls, flooring, roofing, roads, etc. In particular, lightweight prefabricated panels intended for the erection of buildings (load-bearing elements for the structure or insulation panels), lightweight concrete blocks intended to be used as structural, insulating or cladding elements. Other applications include: filler, grout, mortar, gunnite, masonry, bricks or blocks, architectural or cast stonework, retaining walls, wall claddings, panelling, counter panels, roof and floor tiles, pavers, precast stone, cobblestones and agglomerated stones, pipe, reinforced, including prestressed, concrete products, extruded and moulded products and composites. The invention can also be used as insulated sheathing, or thermal insulation.

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of ‘including, but not limited to’.

To provide a more concise description, some of the quantitative expressions given herein are not qualified with the term ‘about’. It is understood that whether the term ‘about’ is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value. In what follows, or where otherwise indicated, ‘%’ will mean ‘weight %’, ‘ratio’ will mean ‘weight ratio’ and ‘parts’ will mean ‘weight parts’. The examples are not intended to limit the scope of the invention.

The terms ‘predominantly’ and ‘substantially’ as used herein shall mean comprising more than 50% by weight, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms ‘preferred’ and ‘preferably’ refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The prior art referred to herein is fully incorporated herein by reference.

### DETAILED DESCRIPTION

The skilled addressee will understand that the invention comprises the embodiments and features disclosed herein as well as all combinations and/or permutations of the disclosed embodiments and features.

### EXAMPLES

The present invention will now be described with reference to the following examples which should be considered in all respects as illustrative and non-restrictive.

Granulated blast furnace slag powder used in the following examples comprised the following properties. The particle size was 320 mesh (44 micrometres).

| | specific | 7 days | | | | |
|---|---|---|---|---|---|---|
| | surface | activity | Ignition | | Liquidity | Water |
| Density | area | index | loss | Chloride | ratio | Content |
| (g/cm³) | (m²/kg) | (%) | (%) | (%) | (%) | (%) |
| 2.9 | 418 | 80 | 0.23 | 0.047 | 98 | 0.4 |

The composition of the borate was ≥99.99 wt % Na₂B₄O₇.5H₂O, and the composition of the sodium carbonate was ≥99.2 Na₂CO₂. Sodium metasilicate pentahydrate was used, and comprised 28-30 wt % sodium oxide (Na₂O), 27-29 wt % silica (SiO₂), and had a particle size of 16-60 mesh.

### Example 1: Prior Art Geopolymer Cement with Borate Retarder

In this example, a prior art geopolymer cement was formulated, comprising: slag, sodium carbonate, and sodium metasilicate, as per the table below. Despite borate retarder being added, the cement gelled and set during the mixing process, i.e. an open time of less than 10 minutes.

| Component | | wt % of solids |
|---|---|---|
| Slag | 100% | 84.7 |
| Sodium carbonate | 8% of slag | 6.8 |
| Sodium metasilicate | 8% of slag | 6.8 |
| Borate | 2% of slag | 1.7 |
| Water | 20% of pre-mix load | |
| Water:cement* ratio | 0.200 | |

*cement (pre-mix load) = weight of slag + sodium carbonate + sodium metasilicate + borate

### Example 2: Prior Art Geopolymer Cement with Borate Retarder and Increased Water

In this example, the same composition as in Example 1 was prepared, but with additional water content, as per the table below. The incorporation of additional water was expected to increase open time. Some open time was observed. However, whilst the formula completed mixing it only flowed for 15 minutes. In this case, whilst the final properties of the cured material were not measured, it would be expected that the compressive strength would be relatively reduced, as the binder was overdosed with water.

| Component | | wt % of solids |
|---|---|---|
| Slag | 100% | 84.7 |
| Sodium carbonate | 8% of slag | 6.8 |
| Sodium metasilicate | 8% of slag | 6.8 |
| Borate | 2% of slag | 1.7 |
| Water | 30% of pre-mix load | |
| Water:cement* ratio | 0.300 | |

*cement (pre-mix load) = weight of slag + sodium carbonate + sodium metasilicate + borate

Both of the open times achieved for Examples 1 and 2 were unacceptable by industry standards, making theses compositions less than ideal for practical industry applications.

### Example 3: Prior Art Geopolymer Cement with Various Concentrations of Borate Retarder

In this example, the same composition as in Example 2 was prepared with additional borate content from 2% up to 5% in 0.25% increments, as per the table below. However, it was observed during these experiments that whilst borate had an impact on the open time, its usefulness as a retarder seemed to plateau at 2.75% of the slag content. No additional open time was achieved using borate concentrations from 2.75% to 5%. Although open times of 20 to 25 minutes were achieved, this is still not sufficient to make the formula usable in practical industry applications. Overdosing with water is likely contributing to the increased open time, but at the expense of reduced compressive strength.

| | | wt % of | | wt % of |
|---|---|---|---|---|
| Component | | solids | | solids |
| Slag | 100% | 84.7 | 100% | 82.6 |
| Sodium carbonate | 8% of slag | 6.8 | 8% of slag | 6.6 |
| Sodium metasilicate | 8% of slag | 6.8 | 8% of slag | 6.6 |
| Borate | 2% of slag | 1.7 | 5% of slag | 4.1 |
| Water | 30% of pre-mix | | 30% of pre-mix | |
| | load | | load | |
| Water:cement* ratio | 0.300 | | 0.300 | |

*cement (pre-mix load) = weight of slag + sodium carbonate + sodium metasilicate + borate

### Example 4: Prior Art Geopolymer Cement with HPMC

In this example, the same composition as in Example 2 was prepared with HPMC as replacement for borate, as per the table below.

| | | wt % of | | wt % of |
|---|---|---|---|---|
| Component | | solids | | solids |
| Slag | 100% | 86.2 | 100% | 83.3 |
| Sodium carbonate | 8% of slag | 6.9 | 8% of slag | 6.7 |
| Sodium metasilicate | 8% of slag | 6.9 | 8% of slag | 6.7 |
| HPMC | 0.05% of slag | 0.04 | 4% of slag | 3.3 |
| Water | 30% of pre-mix | | 30% of pre-mix | |
| | load | | load | |
| Water:cement* ratio | 0.300 | | 0.300 | |

*cement (pre-mix load) = weight of slag + sodium carbonate + sodium metasilicate + HPMC

It was observed that, surprisingly, HPMC provided more open time, of around 40 minutes, but only with loads of 3.5% to 4%. This is still not sufficient to make the composition usable in practical industry applications. Additionally, the introduction of HPMC in these concentrations not only added considerable cost to the formulation, it created severe cracking in the cured geopolymer material. Overdosing with water is likely contributing to the increased open time, but at the expense of reduced compressive strength.

### Example 5: Prior Art Geopolymer Cement with HPMC and Borate

This example was prepared by combining HPMC and borate, as per the table below.

| Component | | wt % of solids |
|---|---|---|
| Slag | 100% | 83.9 |
| Sodium carbonate | 8% of slag | 6.7 |
| Sodium metasilicate | 8% of slag | 6.7 |
| Borate | 2.75% of slag | 2.3 |
| HPMC | 0.5% of slag | 0.42 |
| Water | 30% of pre-mix load | |
| Water:cement* ratio | 0.300 | |

*cement (pre-mix load) = weight of slag + sodium carbonate + sodium metasilicate + borate + HPMC

It was observed that during this experiment that HPMC and borate provided an acceptable open time of around 60 minutes. This was surprising given that the HPMC concentration is only about 10% that used in Example 4, suggesting a synergy between these components of the formulation. A further experiment was undertaken whereby the HPMC concentration was increased by only 0.25% (to a total of 0.75%), and surprisingly the open time increased to around 90 minutes. However, the cracking remained an issue, although was significantly better than Example 4. To attempt to remedy the cracking issue, a further experiment was undertaken with a lower water concentration.

### Example 6: Prior Art Geopolymer Cement with HPMC/Borate and Lower Water Content

In this example, the same composition as in Example 5 with additional HPMC at 0.75% was prepared but with lower water content, as per the table below.

| Component | | wt % of solids |
|---|---|---|
| Slag | 100% | 83.7 |
| Sodium carbonate | 8% of slag | 6.7 |
| Sodium metasilicate | 8% of slag | 6.7 |
| Borate | 2.75% of slag | 2.3 |
| HPMC | 0.75% of slag | 0.63 |
| Water | 20% of pre-mix load | |
| Water:cement* ratio | 0.200 | |

*cement (pre-mix load) = weight of slag + sodium carbonate + sodium metasilicate + borate + HPMC

It was observed that the open time did not decrease with the lower water load, remaining at around between 60-90 minutes. However, the cracking did not improve either. The reduction in water content did not affect the open time, which was a surprising outcome, but was expected to lead to better ultimate compressive strength in the final cured material.

### Example 7: Prior Art Geopolymer Cement with HPMC/Borate and Polymeric Binder

In this example, the same composition as in Example 6 was prepared but with the introduction of the polymeric binder in the form of VAE.

| Component | | wt % of solids |
|---|---|---|
| Slag | 100% | 83.7 |
| Sodium carbonate | 8% of slag | 6.7 |
| Sodium metasilicate | 8% of slag | 6.7 |
| Borate | 2.75% of slag | 2.3 |
| HPMC | 0.75% of slag | 0.63 |
| VAE | 0.25% of slag | 0.2 |
| Water | 20% of pre-mix load | |
| Water:cement* ratio | 0.200 | |

*cement (pre-mix load) = weight of slag + sodium carbonate + sodium metasilicate + borate + HPMC + VAE

The addition of a very small content of VAE had no adverse impact on open time, which remained in a similar range as Example 6. The addition of VAE, did, however reduce the cracking somewhat, and did so at relatively small concentrations. This was surprising, because it was expected that significantly greater concentration of polymeric binder would be required to address the cracking issue that was present in the Example 5 composition.

### Example 8: Prior Art Geopolymer Cement with HPMC/Borate and Increased Polymeric Binder

In this example, the same composition as in Example 7 was prepared but with increased polymeric binder content.

| Component | | wt % of solids |
|---|---|---|
| Slag | 100% | 83.3 |
| Sodium carbonate | 8% of slag | 6.7 |
| Sodium metasilicate | 8% of slag | 6.7 |
| Borate | 2.75% of slag | 2.3 |
| HPMC | 0.75% of slag | 0.63 |
| VAE | 0.50% of slag | 0.4 |
| Water | 20% of pre-mix load | |
| Water:cement* ratio | 0.200 | |

*cement (pre-mix load) = weight of slag + sodium carbonate + sodium metasilicate + borate + HPMC + VAE

The addition of an additional 0.25% VAE (over Example 7) had no adverse impact on open time, and surprisingly the cracking disappeared completely.

### Example 9a and 9b: Investigation of Increased Activator Content

The following examples were prepared with increased activator content, and varying water loads as per the following tables. The purpose of these experiments was to investigate how overdosing the premix with additional activator (sodium carbonate and sodium metasilicate) and water loads, while removing the HPMC and VAE may affect open time and mechanical properties.

Example 9a—Same as example 8 with increased activators

| Component | | wt % of solids |
|---|---|---|
| Slag | 100% | 80.6 |
| Sodium carbonate | 10% of slag | 8.1 |
| Sodium metasilicate | 10% of slag | 8.1 |
| Borate | 2.75% of slag | 2.2 |
| HPMC | 0.75% of slag | 0.60 |
| VAE | 0.50% of slag | 0.4 |
| Water | 20% of premix load | |
| Water:cement* ratio | 0.200 | |

*cement = slag + sodium carbonate + sodium metasilicate

Example 9b—Same as Example 8 with increased activators, without HPMC and VEA Component wt % of solids

| Component | | wt % of solids |
|---|---|---|
| Slag | 100% | 80.6 |
| Sodium carbonate | 10% of slag | 8.1 |
| Sodium metasilicate | 10% of slag | 8.1 |
| Borate | 2.75% of slag | 2.2 |
| HPMC | Nil | |
| VAE | Nil | |
| Water | 30% of premix load | |
| Water:cement* ratio | 0.200 | |

*cement = slag + sodium carbonate + sodium metasilicate

Test samples of the composition set out in the tables above were allowed to cure for 28 days with compressive testing done after 1 day, 7 days, and 28 days. (see table below)

| | Experiment | Experiment | 9a Sam- | 9a Sam- | 9a Sam- |
|---|---|---|---|---|---|
| | 9b Sample | 9a Sample 1 | ple 2 | ple 3 | ple 4 |
| 1 day (MPa) | 15.2 | 41.8 | 43.9 | 43.6 | 42.8 |
| 7 day (MPa) | 31.2 | 87.2 | 86.2 | 89.2 | 86.4 |
| 28 day (MPa) | 43.7 | 103.3 | 93.2 | 108.4 | 101.8 |

Interestingly, Experiment 9b's strength after 1 day at 15.2 MPa, is indicative of a poor open time. If an acceptable open time was achieved that figure should be much lower, and in the order of 8-9 MPa. Secondly, Experiment 9b's 28-day strength is not very high, considering the increase in activators from 8% to 10% (for each of the sodium carbonate and the sodium metasilicate). These figures indicate that the additional 10% water load has adversely affected the final strength of Experiment 9b, while still not providing an exceptionable open time.

Note that Experiment 9a's strength after 1 day at 43 MPa is more than double that of Experiment 9b's but still indicative of a poor open time. But the strength growth over the 28 days culminating at around 100 MPa is an exceptional outcome.

### Example 10: Investigation of Reduction in Activator Concentration

In this example, the same composition as in Example 8 was prepared and the compressive strength measured, as per the following tables.

| Component | | wt % of solids |
|---|---|---|
| Slag | 100% | 83.3 |
| Sodium carbonate | 8% of slag | 6.7 |
| Sodium metasilicate | 8% of slag | 6.7 |
| Borate | 2.75% of slag | 2.3 |
| HPMC | 0.75% of slag | 0.63 |
| VAE | 0.50% of slag | 0.4 |
| Water | 20% of pre-mix load | |
| Water:cement* ratio | 0.200 | |

*cement (pre-mix load) = weight of slag + sodium carbonate + sodium metasilicate + borate + HPMC + VAE

It was observed that the open time was in the order of 24 hours and the set material had little to no strength. This shows that these activator concentrations are insufficient to activate the slag and to form a geopolymer concrete.

### Example 11: Investigation of Reduction in Activator Concentration

In this example, the same composition as in Example 8 was prepared but with reduced activator content, as per the following table.

| Component | | wt % of solids |
|---|---|---|
| Slag | 100% | 83.3 |
| Sodium carbonate | 8% of slag | 6.7 |
| Sodium metasilicate | 8% of slag | 6.7 |
| Borate | 2.75% of slag | 2.3 |
| HPMC | 0.75% of slag | 0.63 |
| VAE | 0.50% of slag | 0.4 |
| Water | 20% of premix load | |
| Water:cement* ratio | 0.200 | |

*cement = slag + sodium carbonate + sodium metasilicate

| | Example 11 |
|---|---|
| 1 day (MPa) | 9.4 |
| 4 day (MPa) | 69.6 |
| 7 day (MPa) | 82.4 |
| 28 day (MPa) | 99.8 |

Note the 1-day strength at 9.4 MPa, is indicative an acceptable open time. Additionally, measured open time between 60-90 minutes have been obtained in real time applications. Also, the formula's growth in strength had ‘caught up’ with Example's 9a and 9b formula's strength outcomes after 7 days, and showed equivalent outstanding ultimate strength after 28 days, while only using 8% activators (sodium carbonate and sodium metasilicate). The above result when reviewed against Examples 9a, 9b and 10 proves that the mix synergy of all the powered components in the premix in conjunction with a low water ratio is unique in obtaining acceptable open time combined with very high ultimate compressive strength in the concrete produced.

### SUMMARY

A prior art geopolymer cement (comprising: slag, sodium carbonate, and sodium metasilicate), even with some borate retarder, has little to no open time. Adding borate retarder at progressively higher concentrations has a diminishing effect on open time, and even at relatively high concentrations does not provide open time sufficient to make the formula usable for practical industry applications. Increasing the water content improves open time marginally but does so at the expense of compressive strength. Also, a higher concentration of activator does not improve ultimate strength, even with low water content.

It has been found that utilising HPMC (instead of borate) provides an increase in open time, but only at relatively high concentrations, and even then, the composition is not usable in practical industry applications. Furthermore, severe cracking of the cured material results when using relatively high concentrations of HPMC.

Surprisingly, reducing the HPMC to relatively low concentrations, and when used in combination with borate, provides an acceptable open time of around 60 minutes, but cracking remains an issue. The present applicant has found that cracking was substantially ameliorated by surprisingly low concentrations of polymeric binder. Furthermore, the inventive compositions disclosed herein display a rate of strength development that is at least equivalent to that of OPC-based concretes, and wherein the ultimate 28-day strength is significantly higher than OPC-based concretes.

When the activator concentration is under 8% the binder either does not cure or does so too slowly to be useful in the field. By increasing the activator concentration to equal to or greater than 10% the strength should develop faster, which would have a negative effect on open time. It was found that additional water can be added to slow down the rate of curing to increase open time, but mechanical properties are relatively low and the open time could not be controlled to the desired range. Although the invention has been described with reference to specific examples, it will be appreciated by those skilled in the art that the invention may be embodied in many other forms. In particular, features of any one of the various described examples may be provided in any combination in any of the other described examples. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A geopolymer cement, comprising:
a geopolymer binder; and
a setting control composition comprising:
a viscosity control agent,
a polymeric binder, and
a retarding additive.

2. A geopolymer cement according to claim 1 wherein the geopolymer binder comprises an aluminosilicate material and an activator.

3. A geopolymer cement according to claim 1 wherein the aluminosilicate material is fly ash and/or slag.

4. A geopolymer cement according to claim 1 wherein the geopolymer binder is present at a concentration of 60 to 99 wt %, preferably 95 wt %.

5. A geopolymer cement according to claim 2 wherein the activator is an alkaline silicate solution.

6. A geopolymer cement according to claim 2 wherein the activator is a mixture of sodium silicate and sodium carbonate.

7. A geopolymer cement according to claim 1 wherein the viscosity control agent is a cellulose based organic polymer selected from the group consisting of: include methylcellulose (MC), methylhydroxyethylcellulose (MHEC), methylhydroxypropylcellulose (MHPC), hydroxyethylcellulose (HEC), ethylhydroxyethylcellulose (EHEC), methylethylhydroxyethylcellulose (MEHEC), hydrophobically modified ethylhydroxyethylcelluloses (HMEHEC), hydrophobically modified hydroxyethylcelluloses (HMHEC), sulfoethyl methylhydroxyethylcelluloses (SEMHEC), sulfoethyl methylhydroxypropylcelluloses (SEMHPC), sulfoethyl hydroxyethylcelluloses (SEHEC), hydroxypropyl-cellulose (HPC), hydroxypropylmethyl-cellulose (HPMC), methyl-cellulose (MC), ethyl-cellulose (EC), methylethyl-cellulose (MEC), carboxymethyl-cellulose (CMC), carboxymethyl-ethyl-cellulose (CMEC), and carboxymethylhydroxyethyl-cellulose (CMREC).

8. A geopolymer cement according claim 1 wherein the viscosity control agent is present at a concentration of 0.1 to 3.0 wt %, preferably 0.7 wt %.

9. A geopolymer cement according to claim 1 wherein the polymeric binder is a redispersible polymer powder selected from vinyl acetate ethylene (VAE) emulsions.

10. A geopolymer cement according to claim 1 wherein the polymeric binder is present at a concentration of 0.1 to 1.5 wt %.

11. A geopolymer cement according to claim 1 wherein the retarding additive is borate.

12. (canceled)

13. A geopolymer cement according to claim 1 wherein the geopolymer cement further comprises other additives selected from the group consisting of: set accelerating agents, air-entraining agents, foaming agents, wetting agents, shrinkage control agents, efflorescence control agents, colouring agents, corrosion control agents, alkali-silica reaction reducing admixtures, discrete reinforcing fibers, and/or other aggregates, lightweight fillers, mineral fillers.

14-16. (canceled)

17. A geopolymer concrete, comprising:
a geopolymer cement according to claim 1,
water, and
aggregate material,
wherein the concrete has a water to cement ratio of between 0.15 to 0.25.

18. A geopolymer concrete according to claim 17 wherein the water:cement ratio is 0.20.

19. A geopolymer concrete according to claim 17 wherein the water:cement ratio is 0.19 or 0.21.

20. A method of making a geopolymer cement, comprising:
combining a geopolymer binder with a setting control composition, the setting control composition comprising:
a viscosity control agent,
a polymeric binder, and
a retarding additive.

21. A method of making a geopolymer concrete, comprising:
combining a solid geopolymer cement according to claim 1, aggregate material, and water, wherein the water to cement ratio is between 0.15 to 0.25.

22. A method for controlling open time in a geopolymer composition, the method comprising:
combining a geopolymer binder with a setting control composition to provide said geopolymer composition, the setting control composition comprising:
a viscosity control agent,
a polymeric binder, and
a retarding additive,
and adding water to the geopolymer composition such that the water to cement ratio is between 0.15 to 0.25,
wherein a sufficient quantity of the setting control composition is added such that the open time is between 30 and 120 minutes.

23. A method for controlling open time in a geopolymer composition, the method comprising:
using a setting control composition comprising:
a viscosity control agent,
a polymeric binder, and
a retarding additive.

24-25. (canceled)
